(19) United States
(12) Patent Application Publication
(10) Pub. No.: US 2013/0285454 A1
(43) Pub. Date: Oct. 31, 2013

(54) SOLAR POWER SYSTEM

(71) Applicants: HUA-ZHENG ZHANG, Shenzhen (CN); YONG-HUI HU, Shenzhen (CN); KAI-KUEI WU, New Taipei (TW); KUN-CHIH HSIEH, New Taipei (TW); KUAN-HONG HSIEH, New Taipei (TW)

(72) Inventors: HUA-ZHENG ZHANG, Shenzhen (CN); YONG-HUI HU, Shenzhen (CN); KAI-KUEI WU, New Taipei (TW); KUN-CHIH HSIEH, New Taipei (TW); KUAN-HONG HSIEH, New Taipei (TW)

(21) Appl. No.: 13/726,235

(22) Filed: Dec. 24, 2012

(30) Foreign Application Priority Data
Apr. 28, 2012 (CN) 201210129049.8

(51) Int. Cl. H02J 15/00

(52) U.S. Cl. CPC H02J 15/00
USPC 307/65

(57) ABSTRACT

A solar power system includes a solar panel for converting solar power into direct current power. The solar power system further includes an electric power detecting device, an elevator mechanism, an electric current control unit and a fixing mechanism. The elevator mechanism mechanically pulls a weight under a direct current motor and drives the direct current motor to rotate to generate electric power when the weigh falls. The electric current control unit outputs the direct current power to the direct current motor when the direct current power is equal to a predetermined value and stops outputting the direct current power when the weight is pulled to a predetermined. The fixing mechanism keeps the weight staying at the predetermined height and enables the weight to fall so that the elevator mechanism driving the direct current motor to rotate to generate electric power.

### BACKGROUND

1. Technical Field

The present disclosure relates to a solar power system.

2. Description of the Related Art

Traditional solar power systems convert solar energy into electric power. The solar power system employs a rechargeable battery for storing the converted electric power, and providing the electric power to loads. However, the rechargeable batteries are usually lead-acid batteries, which will contaminate the environment. Therefore, there is room for improvement within the art.

### BRIEF DESCRIPTION OF THE DRAWING

The components in the drawings are not necessarily drawn to scale, the emphasis instead being placed upon clearly illustrating the principles of the disclosure. Moreover, in the drawing, like reference numerals designate corresponding parts throughout the several views.

FIG. 1 is a schematic diagram of a solar power system in accordance with an exemplary embodiment.

FIG. 2 is a schematic diagram of an elevator mechanism and a fixing mechanism of the solar power system of FIG. 1, in accordance with an exemplary embodiment.

### DETAILED DESCRIPTION

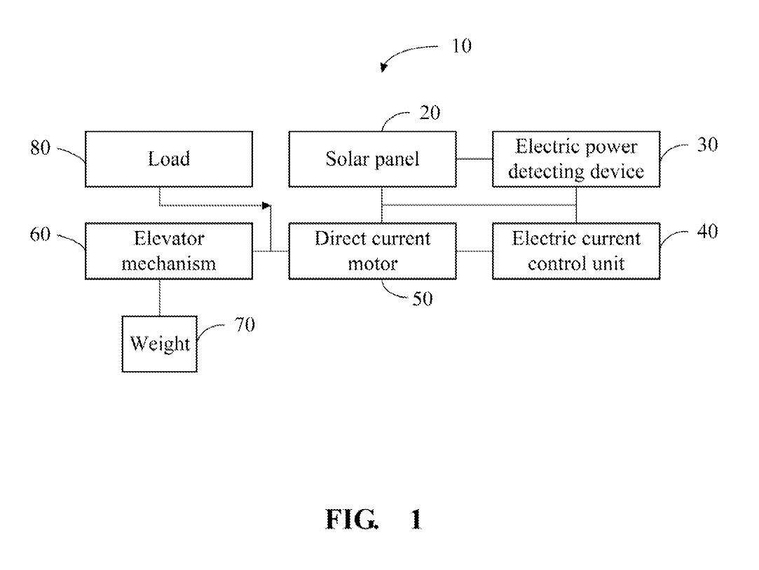

FIG. 1 shows a solar power system 10 of one embodiment. The solar power system 10 includes a solar panel 20, an electric power detecting device 30, an electric current control unit 40, a direct current motor 50, an elevator mechanism 60, a weight 70 connected to the elevator mechanism 60, and a load 80. The electric power detecting device 30 is connected to the solar panel 20 and the electric current control unit 40. The direct current motor 50 is connected to the solar panel 20, the electric current control unit 40, and the load 80. The elevator 60 is connected to the direct current motor 50.

The solar panel 20 is configured for converting solar energy into direct current power. The electric power detecting device 30 is configured for detecting the direct current power converted by the solar panel 20. When the direct current power converted by the solar panel 20 is increased to exceed a predetermined value, the electric power detecting device 30 enables a connection between the solar panel 20 and the electric current control unit 40. As a result the electric current control unit 40 enables the direct current power converted by the solar panel 20 to flow through the direct current motor 50 and power the direct current motor 50 to rotate. The predetermined value is a value of electric power which is consumed by pulling the weight 70 to be at a predetermined height by the elevator mechanism 60. The elevator mechanism 60 is mechanically connected to the direct current motor 50, and configured for pulling the weight 70 to be at the predetermined height driven by the direct current motor 50. When the weight 70 is at the predetermined height, the electric current control unit 40 disables the solar panel 20 to further provide direct current power to the direct current motor 50, which results in the direct current motor 50 stopping.

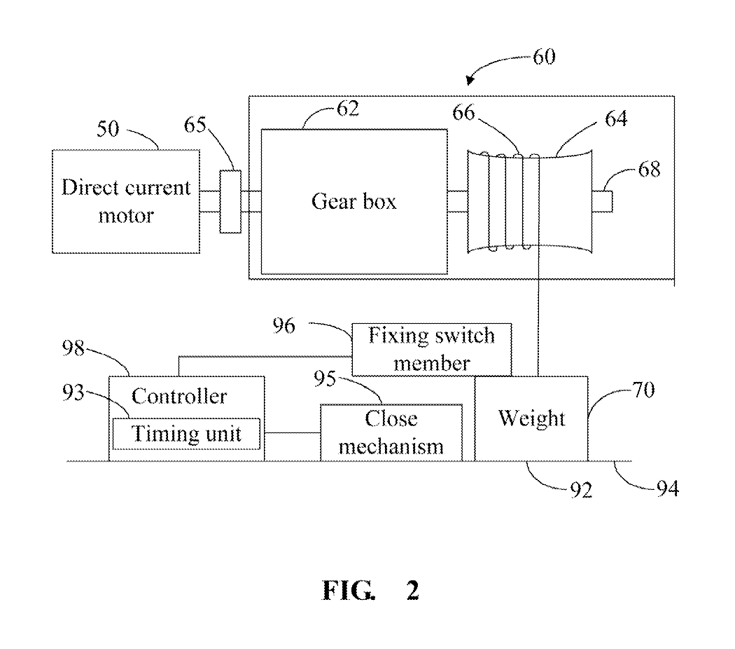

FIG. 2 shows that the solar power system 10 further includes a fixing mechanism (not shown). The fixing mechanism is configured for keeping the weight 70 staying at the predetermined height in a condition, and also enabling the weight 70 to fall in another condition. The fixing mechanism includes a support member 94, a fixing switch member 96, a controller 98 electrically connected to the fixing switch member 96, and a close mechanism 95. The support member 94 defines a through hole 92 therein for the weight 70 to pass through. The fixing switch member 96 is mounted above the through hole 92. The close mechanism 95 is configured for movably closing the through hole 92. The support member 94 is located at the predetermined height. The fixing switch member 96 is spaced away from the through hole 92 for a distance equal to the height value of the weight 70. Thereby, the weight 70 touches the fixing switch member 96 when it moves through the through hole 92. The fixing switch member 96 generates a trigger signal in response to the touch, and transmits the trigger signal to the controller 98. The controller 98 controls the close mechanism 95 to move towards the through hole 92 to close the through hole 92 in response to the trigger signal, thereby the weight 70 staying on the close mechanism 95 when the weight 70 is pulled to be at the predetermined height.

The controller 98 includes a timing unit 93. The controller 98 is further configured for controlling the close mechanism 95 to move away from the through hole 92 to open the through hole 92 when a time value calculated by the timing unit 93 is equal to a predetermined time value, such as pm 7 o'clock. Thereby, the weight 70 drops because of gravity. The elevator mechanism 60 is urged to rotate by the dropping weight 70, and the direct current motor 50 is urged to rotate by the rotating elevator mechanism 60 to generate electric power to provide to the load 80.

The elevator mechanism 60 includes a gear box 62, a coiling block 64, and a rope 66. The gear box 62 is connected to the direct current motor 50 via a coupling 65. The coiling block 64 is mounted on an output shaft 68 of the gear box 62. The rope 66 is wound on the coiling block 64 with an end mounted on the coiling block 64 and the other end connected to the weight 70. The direct current motor 50 drives the gear box 62 to rotate by the direct current power, urging the coiling block 64 to rotate. The rope 66 is wound on the coiling block 64 to pull the weight 70. During the process of the weight 70 drops, the rope 66 is dragged by the dropping weight 70 to urge the gear box 62 to rotate. The direct current motor 50 is urged to rotate by the rotating gear box 62, which results in generating electric power to provide to the load 80. The gear box 62 may include a gear. In the embodiment, the gear box 62 is a transmission mechanism including a plurality of gears, and the rope is a wire rope. In alternative embodiment, the rope is a hemp rope.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A solar power system comprising:
a solar panel configured for converting solar power into direct current power;
an electric power detecting device configured for detecting the direct current power converted by the solar panel;
a direct current motor configured to be powered by the direct current power to rotate;
an elevator mechanism mechanically connected to the direct current motor and a weight, the elevator configured for being driven by the direct current motor to pull the weight to a predetermined height and driving the direct current motor to rotate to generate electric power when the weigh falls;
an electric current control unit configured for enabling the direct current power converted by the solar panel to flow through the direct current motor when the direct current power is equal to a predetermined value, powering the direct current motor to drive the elevator mechanism to pull the weight, and disabling the solar panel to provide the direct current power to the direct current motor when the weight is at the predetermined height, thereby the direct current motor stopping rotating; and
a fixing mechanism configured for keeping the weight staying at the predetermined height, and enabling the weight to fall from the predetermined height to drive the direct current motor to rotate via the elevator mechanism, thereby electric power being generated by the rotating direct current motor and provided to a load.

2. The solar power system as claimed in claim 1, wherein the fixing mechanism comprising:
a support member located at the predetermined height and defining a through hole therein for allowing the weight to move therethrough;
a fixing switch member mounted above the through hole, and configured for generating a trigger signal in response to a touch of the weight on the fixing switch member when the weight is pulled to move upwardly through the through hole to the predetermined height;
a close mechanism; and
a controller electrically connected to the fixing switch member, configured for controlling the close mechanism to move towards the through hole to close the through hole in response to the trigger signal, thereby the weight being intercepted by and staying on the close mechanism, and further configured for controlling the close mechanism to move away from the through hole to open the through hole after a predetermined time has elapsed, which enables the weight to drop.

3. The solar power system as claimed in claim 1, wherein the elevator mechanism comprising:
a gear box mechanically coupled to the direct current motor;
a coiling block mounted on an output shaft of the gear box; and
a rope wound on the coiling block with an end mounted on the coiling block and the other end connected to the weight.

4. The solar power system as claimed in claim 3, wherein the gear box is a transmission mechanism including a plurality of gears
